(19) United States
(12) Patent Application Publication
(10) Pub. No.: US 2012/0041848 A1
(43) Pub. Date: Feb. 16, 2012

(54) TERMINAL, SERVER, AND METHOD FOR CONTENT DISTRIBUTION

(75) Inventor: Sung Chul CHOI, Seoul (KR)

(73) Assignee: PANTECH CO., LTD., Seoul (KR)

(21) Appl. No.: 13/185,282

(22) Filed: Jul. 18, 2011

(30) Foreign Application Priority Data
Aug. 13, 2010 (KR) 10-2010-0078114

(51) Int. Cl. G06Q 30/00

(52) U.S. Cl. 705/27.1; 705/26.1

(57) ABSTRACT

Provided are a user terminal, a server, and a method for content marketing. The method includes purchasing, by a user terminal, content including digital rights management (DRM) information having a selling condition and a purchase condition; and transmitting, by the user terminal, the content to an external terminal based on the purchase condition in the DRM information.

### CROSS-REFERENCE TO RELATED APPLICATION

This application claims priority from and the benefit under 35 U.S.C. §119 of Korean Patent Application No. 10-2010-0078114, filed on Aug. 13, 2010, which is hereby incorporated by reference for all purposes as if fully set forth herein.

### BACKGROUND

1. Field

Exemplary embodiments of the present invention relate to a terminal, a server, and a method for content distribution, and more particularly, to a user terminal, a server, and a method for content distribution, by modifying digital rights management (DRM) information.

2. Discussion of the Background

Digital content may include e-books, downloadable music/movie files, and the like. An e-book, also known as an electronic book, is a digital book in which the content is recorded in an electronic recordable medium. A user may purchase an e-book and download the content to a terminal. A content provider may apply digital rights management (DRM) to e-books. In particular, the content provider generally does not permit the DRM associated content to be easily transferred. As a result, a user cannot share digital content with other users or assign the digital content to other users.

### SUMMARY

Exemplary embodiments of the present invention provide a user terminal, a server, and a method for content distribution in which a content providing company or a user may apply, to digital content such as e-books, various kinds of functions including re-purchasing, sharing, assigning, and the like.

Additional features of the invention will be set forth in the description which follows, and in part will be apparent from the description, or may be learned by practice of the invention.

An exemplary embodiment of the present invention discloses a method for content distribution, the method , includes purchasing, by a terminal, content having a selling condition and a purchase condition; encoding the selling and purchase condition to DRM information; and transmitting, by the terminal, the content to an external terminal based on the purchase condition.

Another exemplary embodiment of the present invention discloses a terminal to process content with digital rights management (DRM) information, the terminal including a communication unit to receive the content from a server if the terminal purchases the content, the DRM information having a seller condition and a purchase condition; and a control unit to determine whether the content is transmissible based on the purchase condition, wherein the communication unit transmits the content to an external terminal if the content is determined to be transmissible.

Another exemplary embodiment of the present invention discloses a method for managing content marketing, including generating, DRM information having a selling condition and a purchase condition; and encoding the content with the DRM information and selling the content to a terminal, wherein the terminal may transmit the purchased content to an external terminal based on the purchase condition.

Another exemplary embodiment of the present invention discloses a system to distribute content, the system including a digital rights management (DRM) generating unit to generate DRM information having a selling condition and a purchase condition; and a server communication unit to transmit the content including the generated DRM information to a terminal, wherein the terminal transmits the content to an external terminal based on the purchase condition.

It is to be understood that both the foregoing general description and the following detailed description are exemplary and explanatory and are intended to provide further explanation of the invention as claimed. Other features and aspects will be apparent from the following detailed description, the drawings and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a content sharing model between a content providing server and a plurality of terminals according to an exemplary embodiment of the present invention.

FIG. 2 illustrates a content sharing model between content providing servers according to an exemplary embodiment of the present invention.

FIG. 3 is a block diagram illustrating a content providing server according to an exemplary embodiment of the present invention.

FIG. 4 illustrates an example of a user interface (UI) used to purchase content if a user accesses a server using a first terminal according to an exemplary embodiment of the present invention.

FIG. 5 illustrates a structure of content having an initial digital rights management (DRM) area according to an exemplary embodiment of the present invention.

FIG. 6 illustrates an example of DRM information in a seller area and a purchaser area of an DRM area that is added to content when the content is purchased according to an exemplary embodiment of the present invention.

FIG. 7 is a block diagram illustrating a terminal according to an exemplary embodiment of the present invention.

FIG. 8 illustrates an example of DRM information included in content transmitted from a terminal to another terminal according to an exemplary embodiment of the present invention;

FIG. 9 illustrates an example of changed DRM information of content stored in a user terminal when the content is transmitted from the terminal to another terminal according to an exemplary embodiment.

FIG. 10 and FIG. 11 are flowcharts illustrating a content distribution method by a digital content transmission system according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

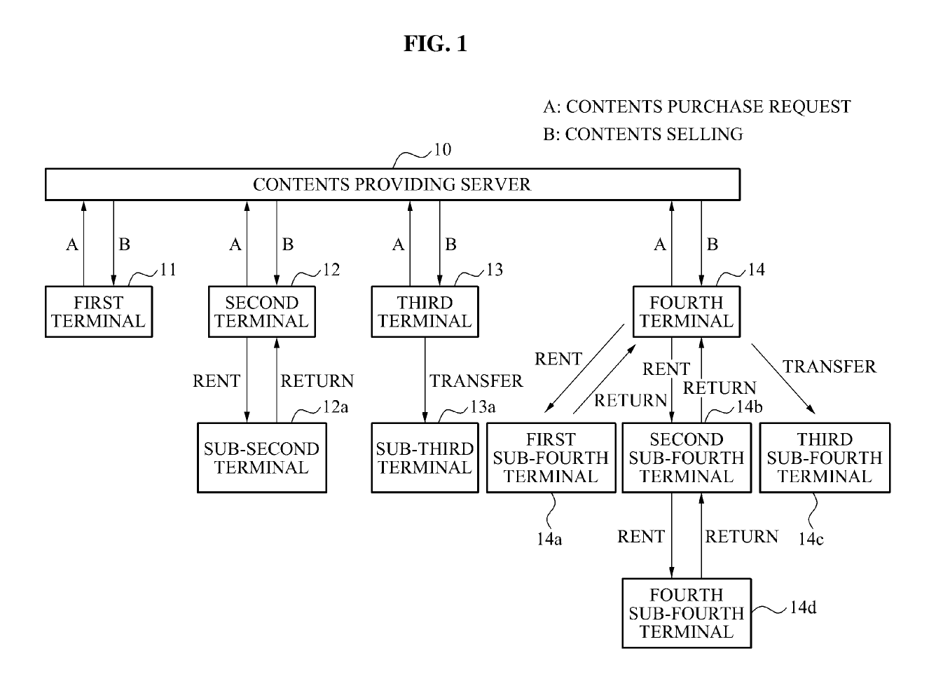

FIG. 1 illustrates a content sharing model between a content providing server and a plurality of terminals according to an exemplary embodiment of the present invention.

Referring to FIG. 1, the content providing server 10 may be a company that sells, or is authorized to sell, content and provides a content selling service. The content may be in digital form, and may include an e-book, a music file, a moving image, a still image, and the like. The content providing server 10 may be authorized to sell content by receiving authorization for the rights of the content, or by any other form of authorization, such as authorship, or by purchasing the rights of the content.

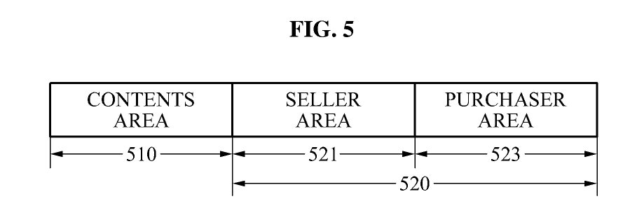

The content providing server 10 may set the price of content based on various characteristics, such as the content being associated with a bestselling book or other like attributes associated with DRM information of digital media. The DRM information may include a selling condition and/or a purchase condition, and may be adjusted by the content providing server 10. An example of DRM information is further described below with reference to FIG. 5. The content providing server 10 may generate content for selling by encoding the content having the price and the DRM information.

In FIG. 1, ‘A’ represents a search request for the purposes of identifying media to purchase from the content providing server 10. For example, the first terminal 11 may search, or request a search, and/or purchase, or request purchase, content from the content providing server 10 using a protocol for requesting information. ‘B’ represents information from the content providing server 10 to enable the first terminal 11 to download and/or buy content associated with the search result. For example, the first terminal 11, using a protocol for transmitting information from the content providing server 10 to the first terminal 11, may purchase and download the content.

The first to fourth terminals 11 to 14 may also directly purchase content from the content providing server 10.

The first terminal 11 may purchase content, with the content being incapable of being distributed or transmitted to another terminal. The first terminal 11 may exclusively use the content purchased from the content providing server 10. In this disclosure, ‘transmission’ may correspond to at least one of transferring, copying, and assigning of the content.

The second terminal 12 may purchase transmissible content from the content providing server 10. The second terminal 12 may rent or lend the purchased content to the sub-second terminal 12a and retrieve the rented content from the sub-second terminal 12a, without intervention or operation of the content providing server 10.

The sub-second terminal 12a may rent the content from the second terminal 12 with or without a charge being associated with the transaction.

The third terminal 13 may purchase assignable content from the content providing server 10. The third terminal 13 may assign or transfer the content and the rights of the content to the sub-third terminal 13a. After which, the third terminal 13 may lose the rights of the content.

The sub-third terminal 13a may take over the rights of the content purchased by the third terminal 13 from the third terminal 13.

The fourth terminal 14 may purchase assignable content from the content providing server 10 and subsequently transmit the purchased content to another terminal. In FIG. 1, when the fourth terminal 14 purchases three licenses, the fourth terminal 14 may rent or assign each license to the first sub-fourth terminal 14a, the second sub-fourth terminal 14b and the third sub-fourth terminal 14c at the same time or different time. If the fourth terminal 14 purchases two licenses, the fourth terminal 14 may not rent or assign each license to the first sub-fourth terminal 14a, the second sub-fourth terminal 14b, and the third sub-fourth terminal 14c at the same time, because there are 2 licenses available to distribute. In this instance, the fourth terminal 14 may retrieve the content and rent or assign the returned content to another terminal.

The first sub-fourth terminal 14a may not be connected, subscribed to, or in communication with the content providing server 10 and may not communicate with the content providing server 10. The first sub-fourth terminal 14a may access the fourth terminal 14 and rent content from the fourth terminal 14. If the fourth terminal 14 has no licenses for the content, the first sub-fourth terminal 14a may not rent the content from the fourth terminal 14. After a rental period of the content has expired, the first sub-fourth terminal 14a may return the content or license of the content to the fourth terminal 14.

The first sub-fourth terminal 14b may rent content from the fourth terminal 14 similar to the first sub-fourth terminal 14a. The second sub-fourth terminal 14b may subsequently rent the rented content to the fourth sub-fourth terminal 14d and retrieve the rented content from the fourth sub-fourth terminal 14d after a rental period of the rented content is expired.

The third sub-fourth terminal 14c may take over content having one license from the fourth terminal 14. After assignment of the content, that is, after transfer of the rights of the content, the content utility range may be determined based on a purchase condition of the content set by the fourth terminal 14 or content providing server 10.

The fourth sub-fourth terminal 14d may request rental of the content rented by the second sub-fourth terminal 14b to the fourth-sub-second terminal 14b. After a rental period of the rented content is expired, the fourth sub-fourth terminal 14d may return the content to the fourth-sub-second terminal 14b.

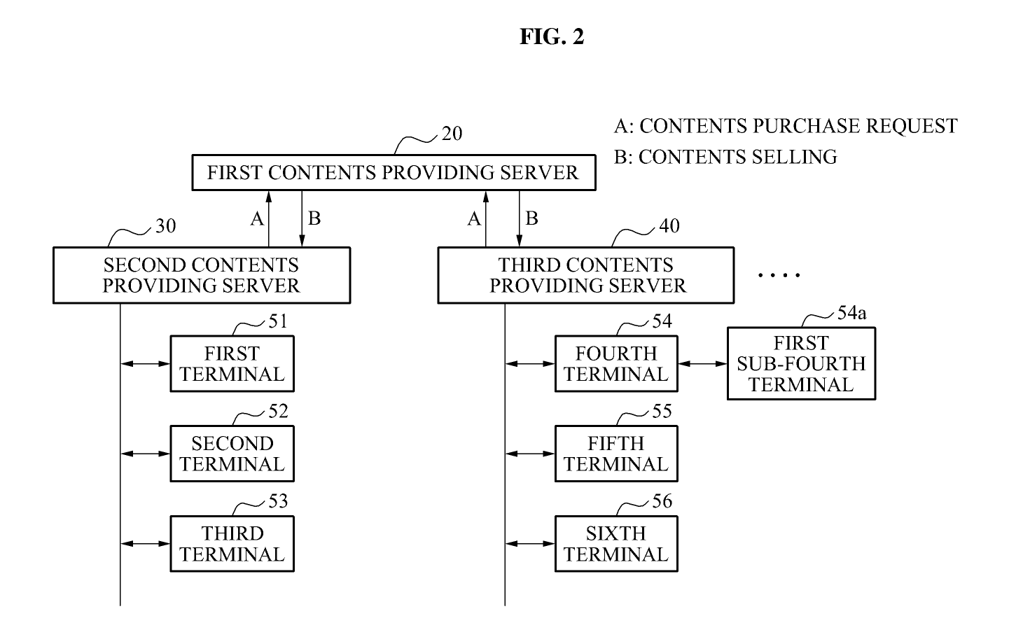

FIG. 2 illustrates a content sharing model between content providing servers according to an exemplary embodiment of the present invention.

Referring to FIG. 2, the first content providing server 20 may be a company authorized to sell or distribute content. In one instance, the company may be a large company, being a leader in content distribution and sales. However, the company is not limited to this scope and may encompass many different sizes. The company may be authorized as an initial seller of content. content The first content providing server 20 may record records of content being sold and distribute, and may adjust a selling condition and a purchase condition of DRM information based on these factors or other factors. The first content providing server 20 may be similar to the content providing server 10 described above with reference to FIG. 1.

In FIG. 2, ‘A’ represents a search request for the purpose of indentifying media to purchase, search, or search and purchase from the first content providing server 20, and ‘B’ represents processes from the first content providing server 20 that may enable the second and third content providing servers 30 and 40 to download a search result and buy content from the first content providing server 20.

The second content providing server 30 may purchase content from the first content providing server 20, and transmit the purchased content to various terminals. In this disclosure, ‘transmission’ may include free or paid transmission, and also may be associated with an operation of renting or selling. The second content providing server 30 may modify a purchase condition in DRM information associated with the content, while not changing a selling condition.

The second content providing server 30 may distribute content to a smaller audience than the first content providing server 20, and may correspond to an offline location. The second content providing server 30 may be a company that provides a content rental service with or without charge, for example, a library, a school, an institute, a content rental store, and the like.

First, second and third terminals 51, 52 and 53 may use the content transmitted from the second content providing server 30 with or without charge, and selectively return the content to the second content providing server 30 after a rental period of the content has expired.

The third content providing server 40 may be identical or similar to the second content providing server 30. That is, the third content providing server 40 may have a specialized content marketing system separate from the first content providing server 20 and distribute content to terminals with or without a charge associated with the distribution of the content.

Fourth, fifth and sixth terminals 54, 55 and 56 may use the content transmitted from the third content providing server 40 with or without charge, and selectively return the content to the third content providing server 40 after a rental period of the content has expired. Also, the fourth terminal 54 may subsequently transmit the content transmitted from the third content providing server 40 to the first sub-fourth terminal 54a.

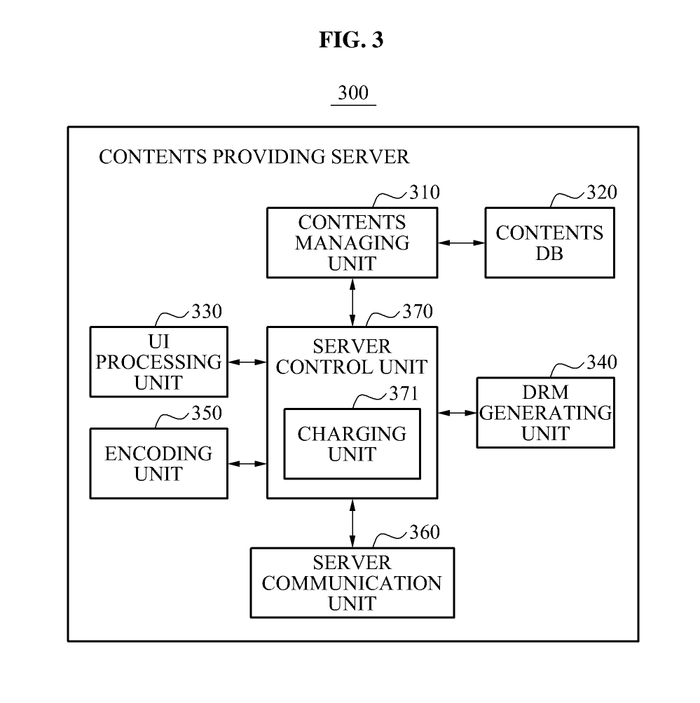

FIG. 3 is a block diagram illustrating a content providing server according to an exemplary embodiment of the present invention.

The content providing server 300 may be similar to the server 10 of FIG. 1 and the servers 20, 30 and 40 of FIG. 2. Referring to FIG. 3, the content providing server 300 may include a content managing unit 310, a content database (DB) 320, a user interface (UI) processing unit 330, a DRM generating unit 340, an encoding unit 350, a server communication unit 360, and a server control unit 370.

The content managing unit 310 may store and manage content, the content may be sellable to a user or another terminal. The content managing unit 310 may store and manage content in the form of a file.

The content DB 320 may store content.

The UI processing unit 330 may generate a UI to be provided for the server 300 to sell the content and process the UI into a display. The UI may be, for example, a web page of the server 300.

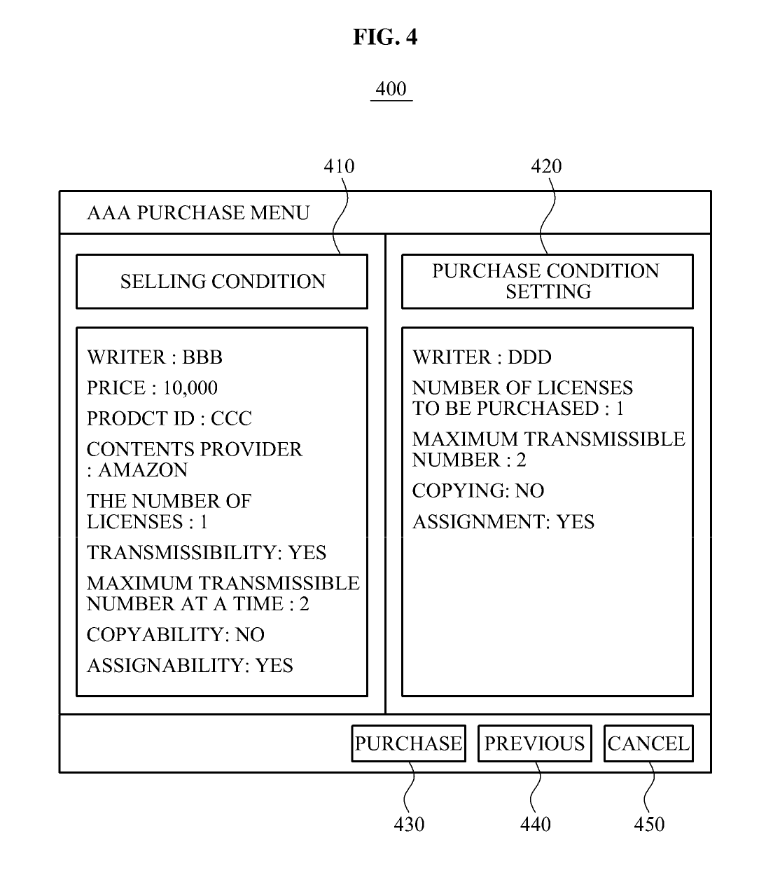

FIG. 4 illustrates an example of a user interface (UI) used to purchase content if a user accesses a server using a first user terminal according to an exemplary embodiment of the present invention.

The UI 400 may be displayed on the first user terminal 700. Referring to FIG. 4, the UI 400 may include a first area 410 for displaying a selling condition, a second area 420 for setting a purchase condition, a button 430 for requesting purchase, a button 440 for requesting movement to a previous page, and a button 450 for requesting purchase cancellation. The user may set a purchase condition in the second area 420 to purchase content named ‘AAA’. The user may set a purchaser, the number of licenses to be purchased, a maximum transmissible number, and set the status of copying and assignment in the second area 420.

The UI processing unit 330 may generate a UI for charging the user if the user selects the button 430. A charging unit 371 may automatically charge the user if the button 430 is selected.

Referring to FIG. 3, the DRM generating unit 340 may generate DRM information using the purchase condition if the first user terminal 700 purchases content. Specifically, the DRM generating unit 340 may generate DRM information including a selling condition if content is sold to a purchaser and a purchase condition if the purchaser purchases the content. The generated DRM information may then be associated with the content.

FIG. 5 illustrates a structure of content having an initial digital rights management (DRM) area according to an exemplary embodiment of the present invention.

Referring to FIG. 5, the structure of content may include a content area 510 and an initial DRM area 520, and the initial DRM area 520 may include a seller area 521 and a purchaser area 523.

The content area 510 is an area for content purchased by a purchaser. If the purchaser purchases an e-book, the content area 510 may include the content of the e-book.

The initial DRM area 520 is an area for DRM information generated by the DRM generating unit 340. A selling condition may be stored in the seller area 521 and a purchase condition may be stored in the purchaser area 523. The seller area 521 may not be modified by the DRM unit 750 of the first user terminal 700, however, the purchaser area 523 may be modified by the DRM unit 750.

The selling condition may be set for each content, regardless of the purchase condition. A manager may set the selling condition and may be a manager of the content providing server 300 or an owner of the content, or the rights of the content. A user may purchase the content under the selling condition. The selling condition may be changed by the manager of the content providing server 300. However, the selling condition may be selectively changed in response to a request by the purchaser or depending on the purchase condition of the content.

At least one of information of detailed information of the content, the number of licenses of the content, a transmissible number of content, a copyable number of the content, and an assignable number of the content may be stored in the seller area 521.

At least one of information of a first purchaser of the content, information of a current owner of the content, the number of currently owned licenses of the content, the number of currently returnable licenses of the content, a transmissible number of the content, a copyable number of the content, an assignable number of the content, and a rental period of the content may be stored in the purchaser area 523.

The number of licenses stored in the purchaser area 523 may correlate to the number of purchases of a single item or content. For example, the number of licenses distributed may be three if three identical e-books are purchased. Accordingly, the first user terminal 700 may obtain three licenses of the content from the content providing server 300 in one download. If the first user terminal 700 transmits one content, that is, one license to the second user terminal (not shown), ‘the number of currently owned licenses’ in DRM information of the content stored in the first user terminal 700 may become ‘2’. The numbers of licenses are provided for exemplary reasons. However, one of skill in the art will understand that different numbers of licenses may be used.

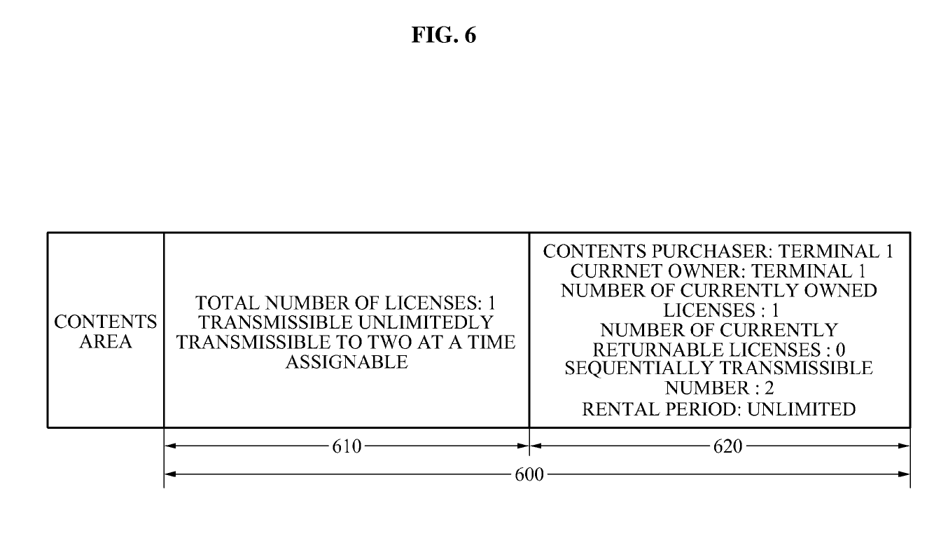

FIG. 6 illustrates an example of DRM information in a seller area and a purchaser area of an DRM area that is added to content when the content is purchased according to an exemplary embodiment of the present invention.

The initial DRM area 600 generated by the content providing server 300 may be included in the content and may be transmitted to the first user terminal 700. Accordingly, the purchase of the content may be completed after transmission.

The selling condition recorded in the seller area 610 shows that the content has one license, may be transmitted unlimitedly and to a maximum of two users at a time, and is assignable.

The purchase condition recorded in the purchaser area 620 shows that a purchase of the content is a ‘terminal 1’, a current owner of the content is the ‘terminal 1’, the number of currently owned licenses of the content is ‘1’, the number of currently returnable licenses of the content is ‘0’, a transmissible number of the content is ‘2’, and a rental period of the content being unlimited.

When the number of currently returnable licenses is ‘0’, it denotes that the content has not been transmitted or shared to another user terminal. If the transmissible number is ‘2’, it means that the content may be transmitted to a maximum of two users. For example, if a user A transmits content to a user B, the transmissible number becomes ‘1’. If the user B transmits the same content to a user C, the transmissible number becomes ‘0’ and the content may be no longer be transmitted. The rental period may be set by a user of a terminal that owns the content. The transmissible number may refer to the number of times content may be subsequently passed from one user to another.

Referring to FIG. 3, the encoding unit 350 may encode the content associated with DRM information. The DRM information may be sourced from the DRM generating unit 340 or any other DRM information sources. The encoding unit 350 may encode the content using certification information from the first user terminal 700 in response to a purchase requested by a purchaser. The certification information may include at least one of a unique number and a personal certificate of the first user terminal 700, and the unique number of the first user terminal 700 may be, for example, an international mobile equipment identity (IMEI) number. The IMEI number may be a serial number of the first user terminal 700 assigned by a manufacturer.

The server communication unit 360 may transmit the encoded content to the first user terminal 700 via a communication network (not shown). The encoded content may be delivered to the user terminal 700 in other ways not described herein, but known in the art.

The server control unit 370 may control the entire operation of the content providing server 300 using a control program, software, a processor, and the like. A charging unit 371 of the server control unit 370 may perform a charging process using certification information. The server control unit 370 may control the encoding unit 350 to encode the content using the certification information if the user has paid for the content.

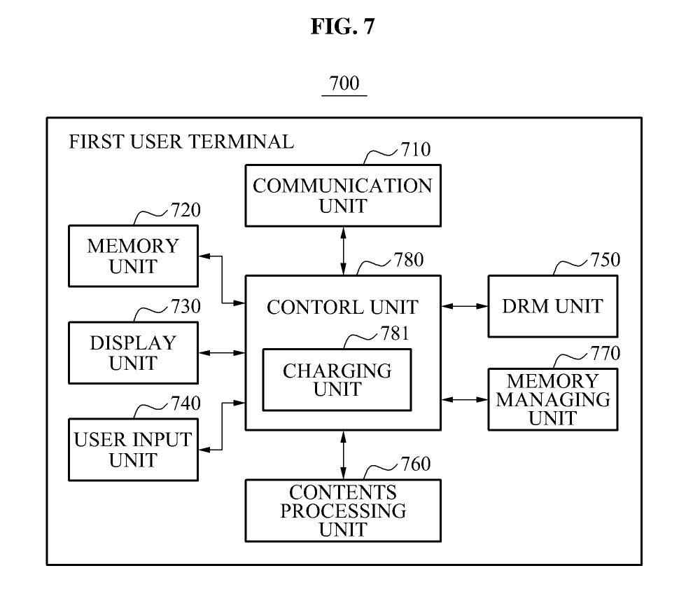

FIG. 7 is a block diagram illustrating a terminal according to an exemplary embodiment of the present invention.

The first user terminal 700 of FIG. 7 may be one of the terminals of FIG. 1 and FIG. 2. Referring to FIG. 7, the first user terminal 700 may include a communication unit 710, a memory unit 720, a display unit 730, a user input unit 740, a DRM unit 750, a content processing unit 760, a memory managing unit 770, and a control unit 780.

The first user terminal 700 may purchase content from the content providing server 300 and transmit the purchased content to at least one external terminal. Hereinafter, a description using a second user terminal (not shown) as the external terminal is provided.

The communication unit 710 may support a wired or wireless communication between the content providing server 300, and the first user terminal 700 and the second user terminal (not shown). For example, the communication unit 710 may receive the purchased content from the content providing server 300.

The memory unit 720 may store the content purchased from the content providing server 300 in the form of a file. Also, the memory unit 720 may store various programs for operating the first user terminal 700. The memory unit 720 may be a non-transitory computer-readable medium.

The display unit 730 may display a UI used to provide various functions of the first user terminal 700, the current status of the first user terminal 700, and the like. In particular, the display unit 730 may display a file list of content stored in the memory unit 720. The file list may include effective files. For example, if content is stored in the memory unit 720, however is not available in the first user terminal 700 as the content was transmitted to the second user terminal (not shown), a file name of the content may not be displayed. In this disclosure, ‘transmission’ may refer to an operation related to movement of the content, for example, transferring, copying, assigning, and the like. The transmitted content may be returned or retrieved from the second user terminal (not shown).

The user input unit 740 may be an operation panel for receiving an input of a user command, and include various Uls, for example, a plurality of buttons, a directional key, a touch panel, and the like. In particular, if a UI, for example, the UI of FIG. 4 is displayed on the display unit 730, an input to the user input unit 740 may set a purchase condition. A command inputted from the user input unit 740 may be transmitted to the control unit 780.

The DRM unit 750 may change DRM information of the content. The DRM unit 750 may change DRM information based on the initial DRM area 520 that is added to the content when the content is purchased from the content providing server 300.

Specifically, the DRM unit 750 may analyze information, such as a selling condition in the seller area 521 of the initial DRM area 520 included in the purchased content, s and manage various file transmission conditions. The file transmission condition may be included in the purchase condition, or may be the purchase condition. If content, that is, a file is transmitted to the second user terminal (not shown), the DRM unit 750 may change the purchase condition in the purchaser area 523, and store DRM information including the changed purchase condition in the content. Also, if the content transmitted to the second user terminal (not shown) is returned, the DRM unit 750 may again change the DRM information of the returned content.

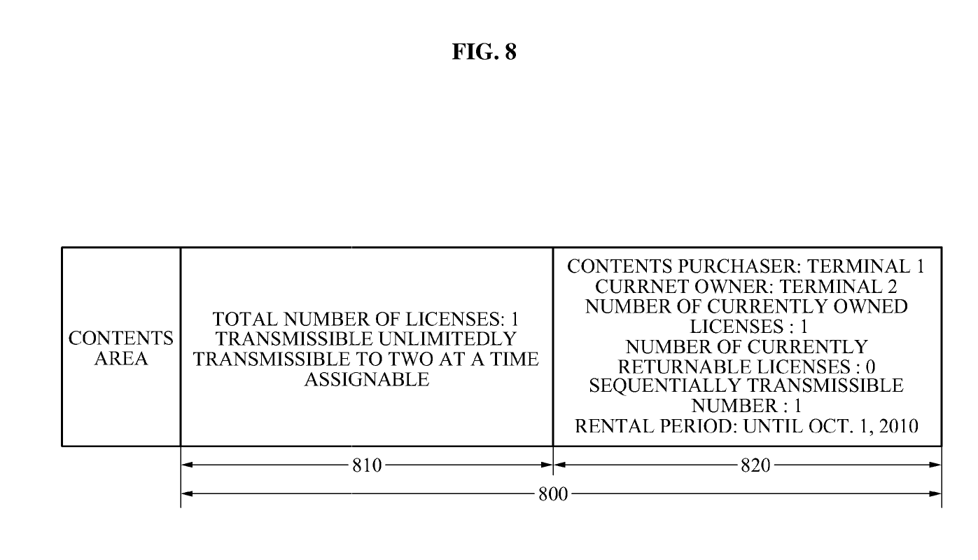

FIG. 8 illustrates an example of DRM information included in content transmitted from a terminal to another terminal(not shown) according to an exemplary embodiment of the present invention.

The DRM information of FIG. 8 may be produced from changing the DRM information stored in the initial DRM area 600 of FIG. 6 by the DRM unit 750.

Referring to FIG. 8, a DRM area 800 of the content transmitted to the second user terminal (not shown) may include a seller area 810 and a purchaser area 820. The seller area 810 may be similar to the seller area of the first user terminal 700 during an initial purchase of the content.

The purchase condition of the purchaser area 820 may be a purchase condition resulting from the change of the purchase condition of the purchaser area 620 by the DRM unit 750 of the first user terminal 700. The purchaser area 820 shows that a purchaser of the content is identical, and a current owner is changed to a ‘terminal 2’. The number of currently owned licenses and the number of currently returnable licenses is ‘1’ and ‘0’, respectively, due to the content being rented from the first user terminal 700 to the second user terminal (not shown).

As the transmissible number is ‘2’ in FIG. 6, a user of the second user terminal (not shown) may transmit the content to an external terminal once, because the transmission of content to the second user terminal decrements the transmissible number by 1.

If the first user terminal 700 sets a rental period and transmits the content to the second user terminal (not shown), the content stored in the second user terminal (not shown) may be deleted after a rental period of the content has expired. Also, the content may be set as DISABLE in the first user terminal, if the content is rented to the second terminal. As such, the content is set as DISABLE. Also, the content in the first user terminal 700 may be changed to ENABLE to release the content lock, so that the content may become available in the first user terminal 700 after the content has been retrieved.

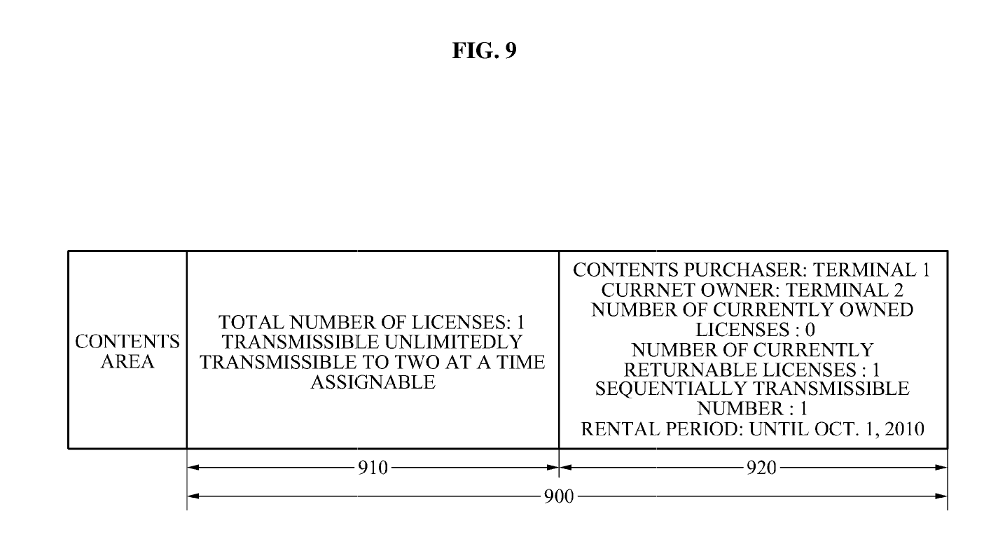

FIG. 9 illustrates an example of changed DRM information of content stored in a user terminal if the content is transmitted from the terminal to another terminal (not shown) according to an exemplary embodiment.

That is, the changed DRM information of FIG. 9 may be information included in the content stored in the first user terminal 700.

Referring to FIG. 9, as the content is transmitted to the second user terminal (not shown), a DRM area 900 of the content stored in the first user terminal 700 may include a seller area 910 and a purchaser area 920. The seller area 910 may be similar to a seller area of the first user terminal 700 during an initial purchase of the content.

The purchase condition of the purchaser area 920 may reflect a purchase condition resulting from the change of the purchase condition of the purchaser area 620 enacted by the DRM unit 750. The purchaser area 920 shows that a purchaser of the content is identical and a current owner is changed to a ‘terminal 2’, the current holder of the content. After the content is rented or transmitted to the second user terminal (not shown), the number of currently owned licenses is decremented to ‘0’ and the number of currently returnable licenses is ‘1’.

If the subsequently transmissible number is ‘2’ in FIG. 6 and the content was transmitted to the second user terminal (not shown) once, the first user terminal 700 may not transmit the content any longer, because the available licenses have been used.

If a rental period is unlimited or not set, and if the content is transmitted to the second user terminal (not shown), the content stored in the first user terminal 700 may be deleted. Conversely, if a rental period is set for a specific time, the content stored in the first user terminal 700 may not be deleted and may be in a DISABLE state as described above. This is to prepare the content for a case where the content may be returned.

If the first user terminal 700 assigns the content to the second user terminal (not shown), the purchaser of the content in FIG. 9 may be changed to a ‘terminal 2’ and the content stored in the first user terminal 700 may be deleted. Thereby, the ownership of the content is changed from one terminal to another.

Referring to FIG. 7, the content processing unit 760 may encode or decode the content received by the communication unit 710. The content processing unit 760 may decode the content using certification information. If the content providing server 300 encodes the content using a unique number of the first user terminal 700, the content processing unit 760 may decode the content using the unique number.

If the purchased content is transmitted to the second user terminal (not shown), the content processing unit 760 may analyze information of the second user terminal (not shown). The information of the second user terminal (not shown) may be one of a unique number and a personal certificate of the second user terminal (not shown). The content processing unit 760 may encode the content including DRM information changed by the DRM unit 750 using the information of the second user terminal (not shown).

If DRM information is changed by the DRM unit 750 or the content is encoded by the content processing unit 760, the memory managing unit 770 may store or delete the content or change the status of the content. In particular, if the encoded content is transmitted to the second user terminal (not shown), the memory managing unit 770 may set the status of the content as DISABLE to perform a content lock, so that the first user terminal 700 may not use the content. If the content is retrieved from the second user terminal (not shown), the memory managing unit 770 may set the status of the content as ENABLE.

The control unit 780 may control the above operation of the first user terminal 700 using a control program, a processor, and the like. For example, the control unit 780 may determine whether the received content is transmissible based on the purchase condition in the DRM information of the content, and may control the communication unit 710 to transmit the content to the second user terminal (not shown) if the control unit 780 determines the content is transmissible.

The charging unit 781 may perform a charging process using certification information of the second user terminal (not shown) if the content stored in the memory unit 720 is rented or re-sold to the second user terminal (not shown) with a charged amount.

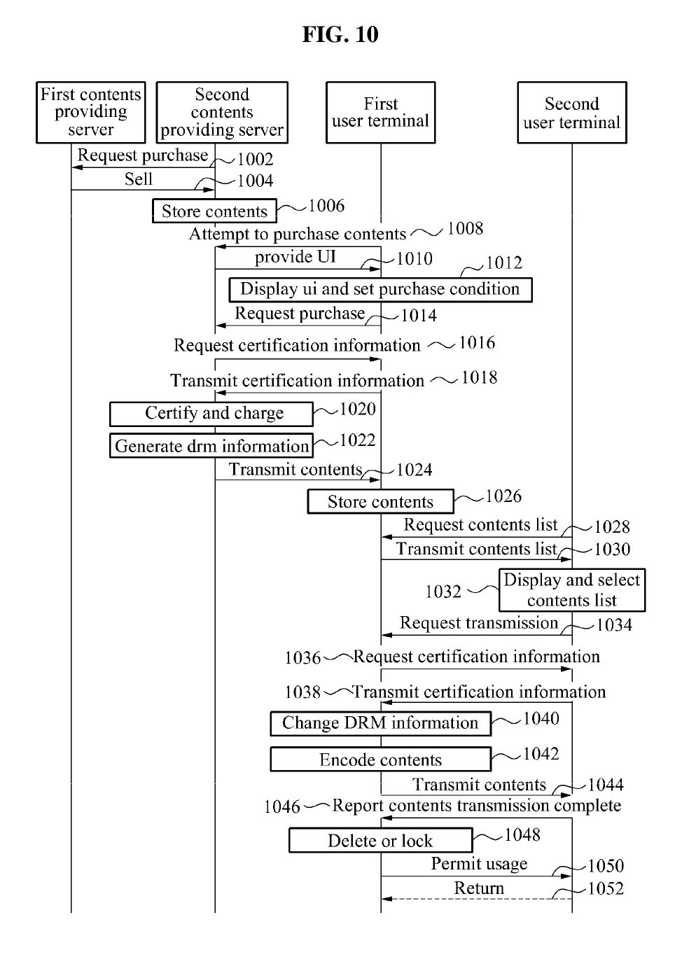

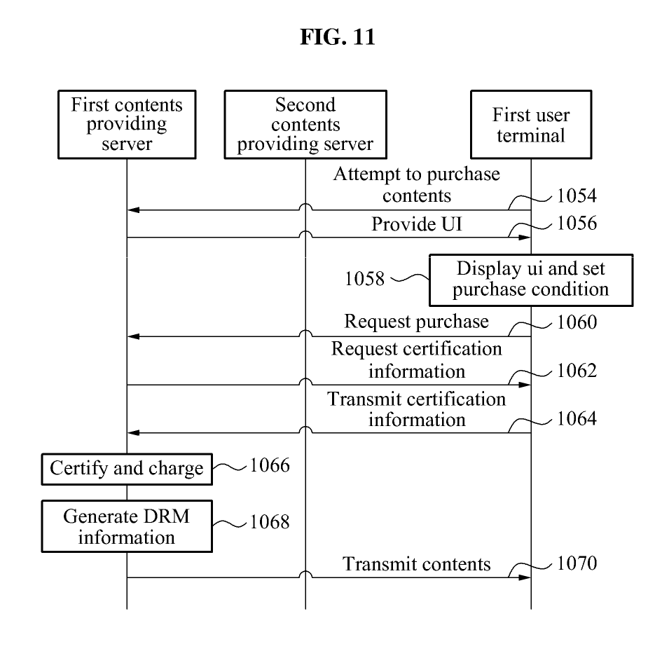

FIG. 10 and FIG. 11 are flowcharts illustrating a content distribution method by a digital content transmission system according to an exemplary embodiment of the present invention.

A first content providing server, a second content providing server, a first user terminal and a second user terminal of FIGS. 10 and 11 may be similar respectively to the first content providing servers 10 and 300, the second content providing server 20, the first user terminal 700, and the second user terminal (not shown) described above with reference to FIGS. 1 to 9.

In operation 1002, the second content providing server may request a purchase of content from the first content providing server.

In operation 1004, the first content providing server may sell the requested content according to a trade process and transmit the content to the second content providing server.

In operation 1006, the second content providing server may store the received content.

In operation 1008, the first user terminal may access the second content providing server and attempt to purchase the content.

In operation 1010, the second content providing server may generate a UI, for example, the UI of FIG. 4, and provide the UI to the first user terminal.

In operation 1012, the first user terminal may display the UI, for example, the UI of FIG. 4, and set a purchase condition as selected or set by a user.

In operation 1014, the first user terminal may request purchase of the content to the second content providing server.

In operation 1016, the second content providing server may request certification information from the first user terminal.

In operation 1018, the first user terminal may transmit, to the second content providing server, one of or both of a unique number and a personal certificate of the first user terminal as the certification information.

In operation 1020, the second content providing server may perform a certifying and charging process using the certification information.

In operation 1022, the second content providing server may generate DRM information using the purchase condition set by the user of the first user terminal.

In operation 1024, the second content providing server may encode the content including the generated DRM information and transmit the encoded content to the first user terminal. Accordingly, selling and purchasing of the content between the second content providing server and the first user terminal may be accomplished.

In operation 1026, the first user terminal may store the purchased content.

In operation 1028, the second user terminal may request the first user terminal to provide a list of content owned by the first user terminal.

In operation 1030, the first user terminal may transmit the list of content to the second user terminal.

In operation 1032, the second user terminal may display the received list and receive an input of desired content from a user.

In operation 1034, the second user terminal may request the first user terminal to transmit the selected content. In this instance, ‘transmission’ may correspond to at least one of transferring, copying, and assigning of the content.

In operation 1036, the first user terminal may request certification information from the second user terminal.

In operation 1038, the second user terminal may transmit one of or both of a unique number and a personal certificate of the second user terminal as the certification information to the first user terminal.

In operation 1040, the first user terminal may perform a certification process using the certification information of the second terminal, and may change DRM information of the content to be stored in the first user terminal and DRM information of the content to be transmitted or assigned to the second user terminal. The DRM information may be changed depending on the purchase condition, for example, the number of licenses at the time of purchasing, the number of currently owned licenses, assignability, and the like.

In operation 1042, the first user terminal may encode the content having the changed DRM information, and in operation 1044, the first user terminal may transmit the encoded content to the second user terminal. In operation 1046, the first user terminal receives a content transmission complete report from the second user terminal.

In operation 1048, the first user terminal may delete or lock the corresponding content, if the first user terminal receives a content transmission complete report from the second user terminal, in operation 1046. For example, if the first user terminal assigns the content to the second user terminal, the first user terminal may delete the content stored in the first user terminal, and if the first user terminal rents the content to the second user terminal, the first user terminal may set the state of the content as DISABLE.

In operation 1050, the first user terminal may transmit usage permission to the second user terminal. Accordingly, the DRM area of the content transmitted to the second user terminal may be extended, so that the second user terminal may use the content.

In operation 1052, the transmitted content may be returned to the first user terminal after a rental period of the DRM area changed in operation 1040 is expired. Operation 1052 need not be performed if the transmission of the content in operation 1044 is assignment of the content.

FIG. 11 illustrates a process for the first user terminal to directly purchase content from the first content providing server according to an exemplary embodiment of the present invention.

In operation 1054, the first user terminal may access the first content providing server and attempt to purchase content.

In operation 1056, the first content providing server may generate a UI, for example, the UI of FIG. 4 and provide the UI to the first user terminal.

In operation 1058, the first user terminal may display the UI, for example, the UI of FIG. 4, and may set a purchase condition as selected by a user of the first user terminal.

In operation 1060, the first user terminal may request a purchase of the content to the first content providing server.

In operation 1062, the first content providing server may request certification information to the first user terminal.

In operation 1064, the first user terminal may transmit one of or both of a unique number and a personal certificate of the first user terminal as the certification information to the first content providing server.

In operation 1066, the first content providing server may perform a certifying and charging process using the certification information.

In operation 1068, the first content providing server may generate DRM information using the purchase condition set by the user of the first user terminal.

In operation 1070, the first content providing server may encode the content associated with the generated DRM information and transmit the encoded content to the first user terminal. Accordingly, selling and purchasing of the content between the first content providing server and the first user terminal may be accomplished.

The exemplary embodiments of the present invention may be applied to programs purchased from application stores as well as content including e-books, music files, movie files, and the like. That is, the programs purchased from application stores may be transmitted or returned according to aspects of the present invention. Also, the exemplary embodiments of the present invention may be applied to various kinds of content depending on a file encoding range.

The exemplary embodiments according to the present invention may be recorded in non-transitory, computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for content distribution, the method comprising:
purchasing, by a terminal, content having a selling condition and a purchase condition;
encoding the selling and purchase condition to DRM information; and
transmitting, by the terminal, the content to an external terminal based on the purchase condition.

2. The method of claim 1, wherein the content includes a DRM area having the DRM information recorded therein, the DRM area including a purchaser area changeable by the terminal and a fixed seller area.

3. The method of claim 2, wherein at least one of information of detailed information of the content, a purchase quantity of the content, a transmissible number of the content, and an assignable number of the content is recorded in the seller area.

4. The method of claim 2, wherein at least one of information of a first purchaser of the content, information of a current owner of the content, the number of currently owned licenses of the content, the number of currently returnable licenses of the content, a transmissible number of the content, an assignable number of the content, and a rental period of the content is recorded in the purchaser area.

5. The method of claim 4, wherein the content is charged to a purchaser according to the purchase condition.

6. The method of claim 1, wherein the terminal changes the purchase condition, encodes the DRM information having the changed purchase condition in the content, and transmits the content to the external terminal.

7. The method of claim 1, wherein the purchasing comprises:
selecting the purchase condition using a user interface provided by a content providing server; and
downloading the content having the selected purchase condition and the selling condition.

8. The method of claim 1, wherein the transmitting comprises renting the content to the external terminal.

9. The method of claim 1, wherein the transmitting comprises assigning the content to the external terminal.

10. The method of claim 8, further comprising:
returning the content from the external terminal to the terminal after a rental period of the content has expired.

11. The method of claim 1, wherein the external terminal modifies the purchase area of the DRM information of the content, and transmits the content to another terminal.

12. A terminal for to process content with digital rights management (DRM) information, the terminal comprising:
a communication unit to receive the content from a server if the terminal purchases the content, the DRM information having a seller condition and a purchase condition; and
a control unit to determine whether the content is transmissible based on the purchase condition,
wherein the communication unit transmits the content to an external terminal if the content is determined to be transmissible.

13. The terminal of claim 12, wherein the content includes a DRM area having the DRM information recorded therein, the DRM area including a purchaser area modifiable by the terminal and a fixed seller area.

14. The terminal of claim 13, wherein at least one of information of detailed information of the content, a purchase quantity of the content, a transmissible number of the content, and an assignable number of the content is recorded in the seller area.

15. The terminal of claim 13, wherein at least one of information of a first purchaser of the content, information of a current owner of the content, the number of currently owned licenses of the content, the number of currently returnable licenses of the content, a transmissible number of the content, an assignable number of the content, and a rental period of the content is recorded in the purchaser area.

16. The user terminal of claim 15, wherein the content is charged to a purchaser based on the purchase condition.

17. The terminal of claim 12, further comprising:
a DRM unit to change the purchase condition; and
a content processing unit to encode the content with the DRM information having the changed purchase condition.

18. The terminal of claim 12, further comprising:
a display unit to display a user interface of the purchase condition, the user interface provided by the server; and
a user input unit to select the purchase condition,
wherein the server transmits the content encoded with the DRM information having the selected purchase condition and the selling condition to the terminal.

19. The terminal of claim 12, wherein the content is rented to the external terminal.

20. The terminal of claim 12, wherein the content is assigned to the external terminal.

21. The user terminal of claim 19, wherein the content from the external terminal is returned to the terminal after a rental period of the content has expired.

22. The terminal of claim 12, wherein the external terminal modifies the DRM information of the content and transmits the content to another terminal.

23. A method for managing content, the method comprising:
generating digital rights management (DRM) information having a selling condition and a purchase condition; and
encoding the content with the DRM information; and
selling the content to a terminal,
wherein the terminal transmits the content to an external terminal based on the purchase condition.

24. The method of claim 23, wherein the content includes a DRM area for the DRM information, the DRM area including a purchaser area modifiable by the terminal and a fixed seller area.

25. A system to distribute content, the system comprising:
a digital rights management (DRM) generating unit to generate DRM information having a selling condition and a purchase condition; and
a server communication unit to transmit the content including the generated DRM information to a terminal,
wherein the terminal transmits the content to an external terminal based on the purchase condition.

26. The system of claim 25, wherein the content includes a DRM area having the DRM information, the DRM area including a purchaser area modifiable by the user terminal and a fixed seller area.
